(19) United States
(12) Patent Application Publication
(10) Pub. No.: US 2008/0066043 A1
(43) Pub. Date: Mar. 13, 2008

(54) METHOD AND SYSTEM FOR CLOCK TREE GENERATION

(76) Inventor: Yung-Hsiu Lin, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/530,033

(22) Filed: Sep. 8, 2006

(51) Int. Cl. G06F 17/50

(52) U.S. Cl. 716/13

(57) ABSTRACT

A method for generating a clock tree between a clock source and a plurality of logic units is disclosed. The logic units are defined to operate according to a clock signal generated from the clock source. The method includes: categorizing the logic units into a plurality of first-level groups according to a first clock skew cost function; and assigning at least a first-level clock buffer to one of the first-level groups for buffering the clock signal outputted from the clock source to the first-level group.

### BACKGROUND OF THE INVENTION

1. Field of the Invention

The present invention relates generally to an integrated circuit design, and more specifically, to a method and system for clock tree generation with logic unit grouping according to clock skew cost function(s).

2. Description of the Prior Art

As known to one skilled in this art, a clock tree is used for buffering a clock signal generated from a clock source to destination clock-driven logic units, such as flip-flops. It is common that the propagation delay time of clock signals supplied to the flip-flops are different for each flip-flop, and a difference of phase associated therewith is called a clock skew. In other words, there is a clock skew problem which affects setup times and hold times of the flip-flops due to imperfection of the clock tree design. One problem, which arises quite often in designing digital logic integrated circuits, is that this skew becomes so large so that the synchronization operation of circuits cannot perform at a desired clock frequency. Therefore, reducing the clock skew is crucial to designing integrated circuits. It is apparent a new and innovative solution is needed so that the clock tree can be generated properly and efficiently.

### SUMMARY OF THE INVENTION

One of the objectives of the claimed invention is to provide a method and system for clock tree generation with logic unit grouping according to clock skew cost function(s).

According to an embodiment of the claimed invention, a method for generating a clock tree between a clock source and a plurality of logic units is disclosed. The logic units are defined to operate according to a clock signal generated from the clock source. The method includes: categorizing the logic units into a plurality of first-level groups according to a first clock skew cost function; and assigning at least a first-level clock buffer to each of the first-level groups for buffering the clock signal outputted from the clock source to a corresponding first-level group.

In addition, a system for generating a clock tree between a clock source and a plurality of logic units is disclosed. The logic units are defined to operate according to a clock signal generated from the clock source. The system comprises: a categorization module, for categorizing the logic units into a plurality of first-level groups according to a first clock skew cost function; and a buffer placement module, for assigning at least a first-level clock buffer to each of the first-level groups for buffering the clock signal outputted from the clock source to a corresponding first-level group.

An integrated circuit, fabricated according to the disclosed clock tree generation scheme, includes: a plurality of logic units each operating according to a clock signal generated from a clock source, wherein the logic units are categorized into a plurality of first-level groups, and the first-level groups are categorized into a plurality of second-level groups; and a clock tree, coupled between the clock source and the logic units. The clock tree comprises: a tree skeleton having at least a bottom-level clock buffer, the tree skeleton being assigned with a specific net length between two buffers disposed at different levels thereof; at least a first-level clock buffer, assigned to each of the first-level groups, for buffering the clock signal outputted from the clock source to a corresponding first-level group; at least a second-level clock buffer, assigned to each of the second-level groups, for buffering the clock signal outputted from the clock source to a corresponding second-level group; and a third-level clock buffer, bridging the second-level clock buffer and the bottom-level clock buffer. A trace length between the third-level clock buffer and the bottom-level clock buffer is equal to the specific net length, and a trace length between the second-level clock buffer and the third-level clock buffer is equal to the specific net length.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a clock tree generation system according to an embodiment of the present invention.

FIG. 2 is a flowchart illustrating a method for generating a clock tree connected between the clock source and the logic units according to one embodiment of the present invention.

FIG. 3(a) is a diagram of a first example of a pre-defined tree skeleton.

FIG. 3(b) is a diagram of a second example of a pre-defined tree skeleton.

FIG. 3(c) is a diagram of a third example of a pre-defined tree skeleton.

FIG. 3(d) is a diagram of a fourth example of a pre-defined tree skeleton.

FIG. 3(e) is a diagram of a fifth example of a pre-defined tree skeleton.

FIG. 4 is a diagram illustrating an integrated circuit having a clock tree in accordance with the method shown in FIG. 2.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising ” are used in an open-ended fashion, and thus should be interpreted to mean “including, but not limited to . . . ”. The terms “couple” and “couples” are intended to mean either an indirect or a direct electrical connection. Thus, if a first device is coupled to a second device, that connection may be through a direct electrical connection, or through an indirect electrical connection via other devices and connections.

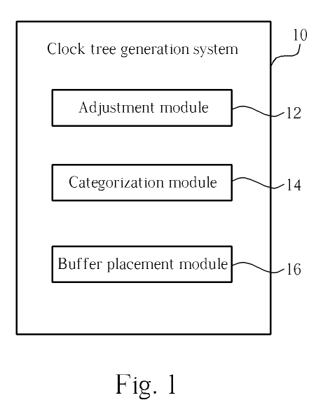

Please refer to FIG. 1. FIG. 1 is a block diagram illustrating a clock tree generation system 10 according to an embodiment of the present invention. As shown in FIG. 1, the clock tree generation system 10 includes an adjustment module, a categorization module 14, and a buffer placement module 16. In one embodiment, the clock tree generation system 10 is implemented using a computer system, where the adjustment module 12, the categorization module 14, and the buffer placement module 16 are program execution codes executed by a microprocessor (not shown) to perform the defined functions. However, in another embodiment, the clock tree generation system 10 is implemented using hardware components only, where the adjustment module 12, the categorization module 14, and the buffer placement module 16 are hardware circuits to perform the defined functions. These alternative designs fall in the scope of the present invention.

In the present invention, the categorization module 14 is provided for categorizing logic units into a plurality of groups according to a clock skew cost function; the buffer placement module 16 is provided for assigning at least a clock buffer to each group for buffering a clock signal outputted from a clock source to a corresponding group; and the adjustment module 12 is provided for adjusting a distribution of the logic units or adding dummy logic units before the categorization module categorizes the logic units driven by the same clock source. Operations of the adjustment module 12, the categorization module 14, and the buffer placement module 16 are detailed as below.

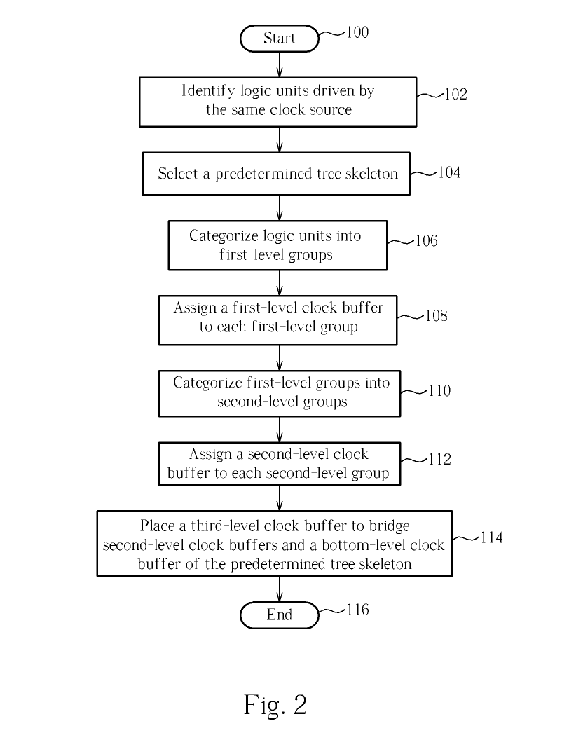

Please refer to FIG. 2 in conjunction with FIG. 1. FIG. 2 is a flowchart illustrating a method for generating a clock tree connected between the clock source and the logic units according to one embodiment of the present invention. The clock tree generation method is performed by the clock tree generation system 10 shown in FIG. 1, and includes the following steps.

Step 100: Start.

Step 102: Identify a plurality of logic units (e.g., flip-flops) driven by the same clock source.

Step 104: Select a predetermined tree skeleton for the logic units, where the predetermined tree skeleton is assigned with a specific net length.

Step 106: Categorize the logic units into a plurality of first-level groups according to a first clock skew cost function.

Step 108: Assign a first-level clock buffer to each first-level group.

Step 110: Categorize the first-level groups of logic units into a plurality of second-level groups according to a second clock skew cost function.

Step 112: Assign a second-level clock buffer to each second-level group.

Step 114: Place a third-level clock buffer to bridge a plurality of second-level clock buffers and a bottom-level clock buffer of the predetermined tree skeleton, wherein a trace length between the third-level clock buffer and the bottom-level clock buffer is equal to the specific net length, and a trace length between a second-level clock buffer and the third-level clock buffer is equal to the specific net length.

Step 116: End.

Please note that the order of steps shown in FIG. 2 could be changed if the same result is substantially obtained. For example, the step of logic unit categorization can be performed before the step of tree skeleton selection.

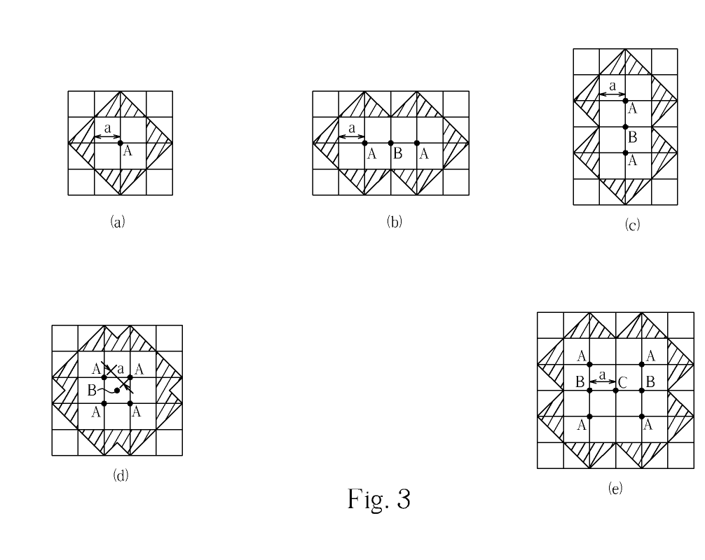

In step 100, the flow starts. In step 102 the categorization module 14 is activated to identify logic units, e.g., flip-flops on an integrated circuit, that are driven by a clock signal generated from a clock source. In other words, the disclosed method generates clock trees for different clock sources, respectively. Next, the categorization module 14 selects a predetermined tree skeleton out of a plurality of pre-defined tree skeletons according to a specific selection rule. In one example, the predetermined tree skeleton is determined according to the distribution of the logic units. Please refer to FIG. 3. FIGS. 3(a)-3(e) are diagrams illustrating different pre-defined tree skeletons respectively. In this embodiment of the present invention, H-tree configurations are utilized. As shown in FIG. 3(a), the tree skeleton contains a single metal level (e.g., a layer 3) and is assigned with a net length a. The node A is defined to be placed with a bottom-level clock buffer. As shown in FIGS. 3(b)-3(d), each of these tree skeletons contains two metal levels (e.g., a layer 3 and a layer 4 above the layer 3) and is assigned with a net length a. The nodes A are defined to be placed with bottom-level clock buffers on layer 3, while the node B is defined to be placed with a clock buffer on a higher level, i.e., layer 4. As shown in FIG. 3(e), the tree skeleton contains three metal levels (e.g., a layer 3, a layer 4 above the layer 3, and a layer 5 above the layer 4) and is assigned with a net length a. The nodes A are defined to be placed with bottom-level clock buffers on layer 3, the nodes B are defined to be placed with a clock buffer at a higher level, i.e., layer 4, and the node C is defined to be placed with a top-level clock buffer on layer 5. In this embodiment, the shaded portions shown in FIGS. 3(a)-3(e) represent areas where the logic units are disposed. Therefore, based on the distribution of the logic units, a tree skeleton can be selected accordingly. It should be noted that the tree skeleton selection mentioned above is for illustrative purposes only, and is not meant to be a limitation on the present invention. For example, in other embodiments, the selection rule could be to check the net length, the number of metal layers, the number of logic units coupled to the same clock source, the buffer driving strength, or the semiconductor process.

In this embodiment, the tree skeleton selection provides a top-down design scheme of building the desired clock tree. For example, if the pre-defined tree skeleton shown in FIG. 3(b) is selected, the fixed positions about the clock buffers on layer 3 and layer 4 are determined. Therefore, the positions of clock buffers to be placed on lower metal layers, such as layer 0, layer 1, and layer 2, need to be determined using a bottom-up design scheme according to the present invention. The bottom-up design scheme is detailed as below.

If step 104 selects the tree skeleton shown in FIG. 3(a), for example, a clock buffer 202 is placed at node A on layer 3 for receiving a clock signal CLK generated from a clock source (e.g., a clock generator). As to the bottom-up design scheme, the categorization module 14 first categorizes the logic units into first-level groups according to a first clock skew cost function (step 106). In this embodiment, the first clock skew cost function is defined to produce a cost value by accumulating electrical characteristic parameters of logic units, for example, the capacitive loading values. When a cost value of the first clock skew cost function calculated by accumulating electrical characteristic parameters of specific logic units reaches one specific value, the specific logic units are categorized into one first-level group. As known to those skilled in this art, the clock skew is in proportion to the capacitance value. Therefore, when an allowable range for clock skew is known, the specific value can be properly decided. For example, the specific value in one embodiment is defined to be a capacitance value of 300 ff. When the result of accumulating capacitance values of ten logic units is equal to the specific value, 300 ff, these ten logic units therefore are gathered in one group. It should be noted that the net capacitance might count into the total capacitance when performing the disclosed categorization process.

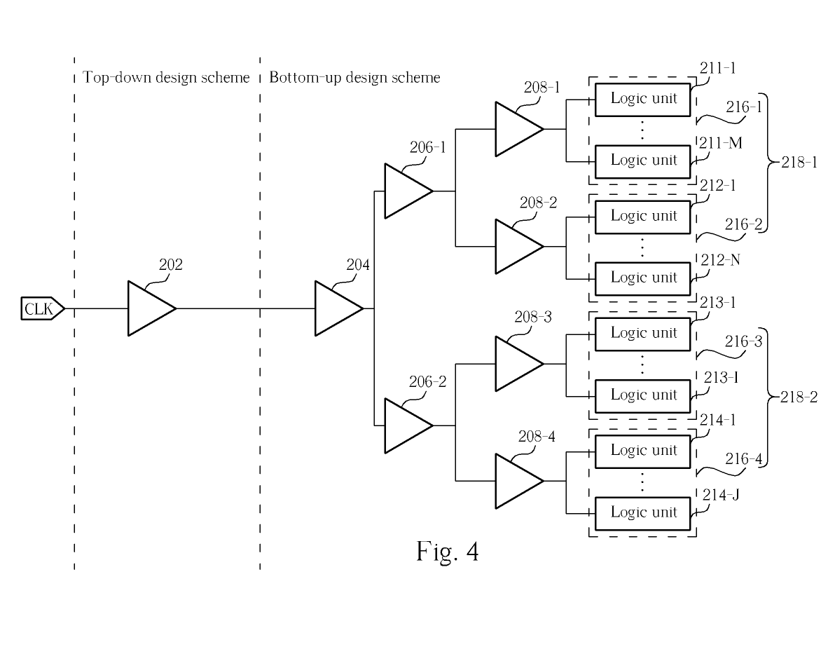

Please refer to FIG. 2 in conjunction with FIG. 4. FIG. 4 is a diagram illustrating an integrated circuit having a clock tree in accordance with the method shown in FIG. 2. As one can see, the logic units 211-1, . . . , 211-M are categorized in one first-level group 216-1; the logic units 212-1, . . . , 212-N are categorized in one first-level group 216-2; the logic units 213-1, . . . , 213-1 are categorized in one first-level group 216-3; and the logic units 214-1, . . . , 214-K are categorized in one first-level group 216-4, where the sum of the capacitive loading values of the logic units in each first-level group is determined to be equal to the aforementioned specific value, 300 ff. The buffer placement module 16 then assigns first-level clock buffers 208-1, 208-2, 208-3, 208-4 to first-level groups 216-1, 216-2, 216-3, 216-4 (step 108) respectively. In this embodiment, the first-level clock buffers 208-1, 208-2, 208-3, 208-4 are placed on layer 0.

After the first-level clock buffers 208-1, 208-2, 208-3, 208-4 are determined, the categorization module 14 further categorizes the first-level groups 216-1, 216-2, 216-3, 216-4 into a plurality of second-level groups 218-1, 218-2 according to a second clock skew cost function (step 110). Similar to the operation of the first clock skew cost function, the second clock skew cost function is defined to produce a cost value by accumulating electrical characteristic parameters of logic units, for example, the capacitive loading values. If the cost value reaches another specific value, the corresponding first-level groups are gathered in one second-level group. As shown in FIG. 4, the first-level groups 216-1 and 216-2 belong to a second-level group 218-1, and the first-level groups 216-3 and 216-4 belong to another second-level group 218-2. Next, the buffer placement module 16 assigns second-level clock buffers 206-1, 206-2 to second-level groups 218-1, 218-2 respectively (step 112). In this embodiment, the second-level clock buffers 206-1, 206-2 are placed on layer 1.

After the second-level clock buffers 206-1, 206-2 are determined, the net length of the selected tree skeleton is referenced to bridge the bottom-level clock buffer 202 and the second-level clock buffers 206-1, 206-2 (step 114). In this embodiment, the buffer placement module 16 determines a location where a trace length between a third-level clock buffer 204 and the bottom-level clock buffer 202 is equal to the net length and a trace length between each of the second-level clock buffers 206-1, 206-2 and the third-level clock buffer 204 is equal to the specific net length, and then places the third-level clock buffer 204 thereon to complete the clock tree generation. In other words, in this embodiment of the present invention a minimum-same-distance-path method is applied so as to determine the location of the third-level clock buffer 204.

It should be noted that in FIG. 4 the number of logic units, the number of first-level groups, and the number of second-level groups are for illustrative purposes, and are not limitations on the present invention. Additionally, step 106/step 110 can be modified by checking if a cost value calculated by accumulating electrical characteristic parameters of specific logic units falls in a specific range, and then categorizes the specific logic units into one first-level group when the calculated cost value falls in the specific range. In this alternative design, the defined specific range is able to provide tolerance in case the actually routed net length is too long to meet the clock skew limitations.

Moreover, please note that all of the clock buffers placed in the created clock tree correspond to a same type of buffer. For instance, each of the clock buffers 202, 204, 206-1, 206-2, 208-1, 208-2, 208-3, 208-4 shown in FIG. 4 has the same driving strength. In addition, in this embodiment of the present description the clock buffers can be implemented by non-inverting buffers or inverting buffers (generally referred to as “inverters”), or a combination of both, as long as the desired polarity of the clock signal fed into corresponding logic units is maintained.

As to the categorization operation mentioned above, the embodiment of the present invention further provides some features relating to clock tree tuning. Before the categorization module 14 categorizes the logic units, the adjustment module 12 is capable of adjusting a distribution of the logic units or adding at least a dummy logic unit to the logic units according to the distribution of the logic units. For example, when the logic units are not distributed uniformly, the adjustment module 12 moves some logic units disposed in a dense area to a sparse area; and when it is difficult to categorizing all logic units into groups according to the defined specific value or range, the adjustment module 12 adds some dummy logic units to the sparse area to make the generation of logic unit groups successful. Additionally, in order to reduce the driving strength requirements of the clock buffers, the buffer placement module 16 can further divide a specific group into a plurality of sub-groups, and assigns a plurality of clock buffers to the sub-groups respectively. For instance, the buffer placement module 16 divides the first-level group 216-1 into a plurality of sub-groups, and assigns a plurality of first-level clock buffers to the sub-groups respectively to thereby reduce buffer driving strength required by the original first-level clock buffer 208-1. Similarly, the buffer placement module 16 is able to divide the second-level group 218-1 into a plurality of sub-groups, and assigns a plurality of second-level clock buffers to the sub-groups respectively to thereby reduce buffer driving strength required by the original second-level clock buffer 206-1. These alternative designs all fall in the scope of the present invention.

This invention can be also applied in a low-power design application. In an embodiment for low-power design, the clock tree generation scheme of the present invention can replace some or all of the clock buffers disposed on a specific layer by well-known integrated clock gating (ICG) cells. In this embodiment for low-power design, the categorization module 14 initially separates a plurality of target logic units of an integrated circuit into a plurality of logic unit groups, respectively, according to logic unit attributes. For example, the target logic units are categorized into logic unit groups according to different functions or other known parameters, where the target logic units in the same logic unit group are allowed to be turned off at the same time when the integrated circuit operates. For each logic unit group identified by the categorization module 14, the clock tree generation method shown in FIG. 2 is executed to generate a clock tree, and then at least one clock buffer disposed at a specific position of a specific layer is replaced by an ICG cell to obtain the low-power design as desired. Since the ICG cell insertion is well known to those skilled in this art, further description is omitted here for brevity. It should be noted that the aforementioned steps associated with replacing the clock buffers by ICG cells are for illustrative purposes only. Other alternative designs are possible by referencing the teachings shown in FIG. 2 in conjunction with any known low-power design techniques. These still obey the spirit of the present invention, and fall in the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating a clock tree between a clock source and a plurality of logic units, the logic units being defined to operate according to a clock signal generated from the clock source, the method comprising:
categorizing the logic units into a plurality of first-level groups according to a first clock skew cost function; and
assigning at least a first-level clock buffer to one of the first-level groups for buffering the clock signal outputted from the clock source to the first-level group.

2. The method of claim 1, wherein the step of categorizing the logic units into the first-level groups comprises:
utilizing the first clock skew cost function to accumulate first type of electrical characteristic parameters of specific logic units; and
when a cost value of the first clock skew cost function calculated by accumulating first type of electrical characteristic parameters of the specific logic units reaches one specific value, the specific logic units are categorized into one first-level group.

3. The method of claim 2, wherein the first type of electrical characteristic parameters are capacitive loading values.

4. The method of claim 1, wherein the step of categorizing the logic units into the first-level groups comprises:
utilizing the first clock skew cost function to accumulate first type of electrical characteristic parameters of specific logic units; and
when a cost value of the first clock skew cost function calculated by accumulating first type of electrical characteristic parameters of the specific logic units falls in one specific range, the specific logic units are categorized into one first-level group.

5. The method of claim 4, wherein the first type of electrical characteristic parameters are capacitive loading values.

6. The method of claim 1, wherein the step of assigning at least a first-level clock buffer to one of the first-level groups comprises:
dividing a specific first-level group into a plurality of sub-groups; and
assigning a plurality of first-level clock buffers to the sub-groups respectively to thereby reduce buffer driving strength requirement.

7. The method of claim 1, further comprising:
categorizing the first-level groups into a plurality of second-level groups according to a second clock skew cost function; and
assigning at least a second-level clock buffer to one of the second-level groups for buffering the clock signal outputted from the clock source to the second-level group.

8. The method of claim 7, wherein the step of assigning at least a second-level clock buffer to one of the second-level groups comprises:
dividing a specific second-level group into a plurality of sub-groups; and
assigning a plurality of second-level clock buffers to the sub-groups to thereby reduce buffer driving strength requirement.

9. The method of claim 7, further comprising:
selecting a predetermined tree skeleton for the logic units, wherein the predetermined tree skeleton includes at least a bottom-level clock buffer; and
bridging the second-level clock buffer and the bottom-level clock buffer of the predetermined tree skeleton.

10. The method of claim 9, wherein the predetermined tree skeleton is assigned with a specific net length, and the step of bridging the second-level clock buffer and the bottom-level clock buffer of the predetermined tree skeleton comprises:
placing a third-level clock buffer to bridge the second-level clock buffer and the bottom-level clock buffer, wherein a trace length between the third-level clock buffer and the bottom-level clock buffer is equal to the specific net length, and a trace length between the second-level clock buffer and the third-level clock buffer is equal to the specific net length.

11. The method of claim 10, wherein all clock buffers implemented in the clock tree correspond are of the same type.

12. The method of claim 9, wherein the predetermined tree skeleton corresponds to an H-tree configuration.

13. The method of claim 7, wherein the step of categorizing the logic units into the first-level groups comprises:
utilizing the first clock skew cost function to accumulate first type of electrical characteristic parameters of specific logic units; and
when a cost value of the first clock skew cost function calculated by accumulate first type of electrical characteristic parameters of the specific logic units reaches one specific value or one specific range, the specific logic units are categorized into one first-level group; and
the step of categorizing the first-level groups into the second-level groups comprises:
utilizing the second clock skew cost function to accumulate second type of electrical characteristic parameters of specific logic units in each first-level group; and
when a cost value of the second clock skew cost function calculated by accumulate second type of electrical characteristic parameters of specific first-level groups reaches another specific value or another specific range, the specific first-level groups are categorized into one second-level group.

14. The method of claim 13, wherein the first type of electrical characteristic parameters and the second type of electrical characteristic parameters are capacitive loading values.

15. The method of claim 1, further comprising:
adjusting a distribution of the logic units before categorizing the logic units.

16. The method of claim 1, further comprising:
adding at least a dummy logic unit to the logic units according to a distribution of the logic units before categorizing the logic units.

17. The method of claim 1, further comprising:
referencing logic unit attributes for selecting the logic units out of a plurality of target logic units of an integrated circuit, wherein the logic units are allowed to be turned off at the same time when the integrated circuit operates;
wherein at least a clock buffer is implemented by an integrated clock gating (ICG) cell.

18. A system for generating a clock tree between a clock source and a plurality of logic units, the logic units being defined to operate according to a clock signal generated from the clock source, the system comprising:
a categorization module, for categorizing the logic units into a plurality of first-level groups according to a first clock skew cost function; and
a buffer placement module, for assigning at least a first-level clock buffer to one of the first-level groups for buffering the clock signal outputted from the clock source to the first-level group.

19. An integrated circuit, comprising:
a plurality of logic units each operating according to a clock signal generated from a clock source, wherein the logic units are categorized into a plurality of first-level groups, and the first-level groups are categorized into a plurality of second-level groups; and
a clock tree, coupled between the clock source and the logic units, the clock tree comprising:
a tree skeleton having at least a bottom-level clock buffer, the tree skeleton being assigned with a specific net length;
at least a first-level clock buffer, assigned to each of the first-level groups, for buffering the clock signal outputted from the clock source to a corresponding first-level group;
at least a second-level clock buffer, assigned to each of the second-level groups, for buffering the clock signal outputted from the clock source to a corresponding second-level group; and
a third-level clock buffer, bridging the second-level clock buffer and the bottom-level clock buffer;
wherein a trace length between the third-level clock buffer and the bottom-level clock buffer is equal to the specific net length, and a trace length between the second-level clock buffer and the third-level clock buffer is equal to the specific net length.
